(19) United States
(12) Patent Application Publication
(10) Pub. No.: US 2018/0086066 A1
(43) Pub. Date: Mar. 29, 2018

(54) PLATE BODY, LIQUID EJECTION HEAD, AND LIQUID EJECTION RECORDING APPARATUS

(71) Applicant: SII Printek Inc., Chiba-shi (JP)

(72) Inventor: Daiki IROKAWA, Chiba-shi (JP)

(21) Appl. No.: 15/704,786

(22) Filed: Sep. 14, 2017

(30) Foreign Application Priority Data
Sep. 29, 2016 (JP) 2016-191716

(51) Int. Cl. B41J 2/14

(52) U.S. Cl. CPC B41J 2/1433

(57) ABSTRACT

A plate body includes: a nozzle plate that is provided on an actuator plate having a plurality of channels to be filled with a liquid and has a nozzle array composed of a plurality of nozzle holes communicating separately with the plurality of channels; and a nozzle cover plate that is provided on a discharge surface of the nozzle plate from which the liquid is discharged and has an opening communicating with at least one of the nozzle holes. The opening is formed such that a direction crossing a direction of the nozzle array and a direction orthogonal to the direction of the nozzle array constitutes a longitudinal direction of the opening.

### RELATED APPLICATIONS

This application claims priority under 35 U.S.C. § 119 to Japanese Patent Application No. 2016-191716 filed on Sep. 29, 2016, the entire content of which is hereby incorporated by reference.

### BACKGROUND OF THE INVENTION

### Technical Field

The present invention relates to a plate body, a liquid ejection head, and a liquid ejection recording apparatus.

### Related Art

A liquid ejection recording apparatus (inkjet printer) for producing various prints includes a conveyor device that conveys a recording medium and a liquid ejection head (inkjet head). The liquid ejection head used in this case supplies a liquid (ink) from a liquid tank (ink tank) to the liquid ejection head via a liquid supply tube (ink supply tube). Then, the ink is discharged from a head chip provided in the liquid ejection head onto the recording medium to make records.

The foregoing head chip includes a nozzle plate having a nozzle array composed of a plurality of nozzle holes and an actuator plate bonded to the nozzle plate and having a plurality of channels communicating with the nozzle holes. The liquid is charged into the channels to form proper menisci in the nozzle holes. The actuator plate has electrodes fondled on wall portions defining the plurality of channels. A voltage is applied to the electrodes to defoiin the wall portions and generate pressure fluctuations in the liquid in the channels. This allows the ink to be discharged via the nozzle holes in the nozzle plate.

The nozzle plate is formed from a resin in many cases for accurately processing the nozzle holes. In addition, a metallic cover plate may be provided on the nozzle plate in order to suppress adhesion of the liquid or the like to the discharge surface of the nozzle plate and protect the nozzle plate. The cover plate covers the entire discharge surface of the nozzle plate. The cover plate has a plurality of openings (discharge holes) at positions corresponding to the nozzle holes to communicate with the nozzle holes. The openings are formed in a circular shape larger in diameter than the nozzle holes. Forming the openings in such a shape makes it possible to cover the circumferences of the nozzle holes with the cover plate as much as possible so as to suppress the adhesion of the liquid or the like to the discharge surface of the nozzle plate.

### SUMMARY OF THE INVENTION

When the liquid is initially charged into the head chip or the liquid is discharged from the head chip, the liquid may be scattered around. In this case, the direct adhesion of the liquid to the nozzle plate can be suppressed but the liquid adheres to the cover plate. Accordingly, the liquid ejection recording apparatus is provided with a wiper to wipe the cover plate off the liquid or the like by wiping action (wiping) of the wiper.

However, when the openings in the cover plate are formed in a circular shape larger in diameter than the nozzle holes as in the foregoing conventional technique, the liquid or the like on the cover plate may be dragged by the wiper in the course of the wiping action and flow into the openings. Then, the liquid having flown into the openings may remain in the openings near the nozzle holes and further reach the nozzle holes. In this case, the menisci of the liquid foiined in the nozzle holes may be broken.

In addition, there has been increasing demand for higher resolution of images and characters recorded on recording media in recent years. In response to the demand, it has been contemplated to narrow the pitch of the nozzle holes. When the pitch of the nozzle holes is narrowed, the adjacent openings come closer to each other and may communicate with each other. In this case, the liquid having flown into the openings may further spread so as to break the menisci in the plurality of nozzle holes.

The present invention is devised in light of the foregoing circumstances. An object of the present invention is to provide a plate body, a liquid ejection head, and a liquid ejection recording apparatus that protect the nozzle plate and prevent breakage of the menisci of the liquid formed in the nozzle holes.

To achieve the above object, a plate body according to the present invention includes: a nozzle plate that is provided on an actuator plate having a plurality of channels to be filled with a liquid and has a nozzle array composed of a plurality of nozzle holes respectively communicating with the plurality of channels; and a cover plate that is provided on a discharge surface of the nozzle plate from which the liquid is discharged and has an opening communicating with at least one of the nozzle holes, in which the opening is formed such that a direction crossing a direction of the nozzle array and a direction orthogonal to the direction of the nozzle array constitutes a longitudinal direction of the opening.

According to this configuration, for example, when a wiper is moved in either the direction of the nozzle array (along the longer direction of the plate body) or the direction orthogonal to the direction of the nozzle array (along the shorter direction of the plate body) to wipe the cover plate off the liquid or the like, the liquid or the like having flown into the opening can be collected to the both ends of the longitudinal direction of the opening. That is, the liquid or the like having flown into the opening can be collected to the positions as distant from the nozzle hole as possible. Accordingly, it is possible to protect the nozzle plate by the cover plate and prevent the breakage of the menisci in the liquid formed in the nozzle holes due to the liquid or the like having flown into the openings.

In the plate body according the present invention, the opening is formed such that a projection length along the direction of the nozzle array is smaller than a projection length along the direction orthogonal to the direction of the nozzle array.

This configuration makes it easy to faun the space between the adjacent openings while narrowing the pitch of the nozzle holes as much as possible. This prevents the openings from communicating with each other as much as possible.

In the plate body according to the present invention, the cover plate has the respective openings for each of the nozzle holes.

Even when the openings are formed in the cover plate in correspondence with the nozzle holes, the direction crossing the two directions constitutes the longitudinal direction. Accordingly, the liquid or the like having flown into the openings can be collected to the positions as separated from the nozzle holes as possible.

In addition, the nozzle plate can be covered by the cover plate as much as possible to protect the nozzle plate reliably by the cover plate.

Further, even though the opening areas of the openings are set to be larger than the opening areas of the nozzle holes, the openings can be made as small in width as possible along the direction of the nozzle array. This prevents the adjacent openings from communicating with each other and avoids the spread of the liquid or the like on the cover plate.

In the plate body according to the present invention, the opening has an oval shape.

According to this configuration, the inner peripheral edge of the opening can be made smooth to move the liquid or the like having flown into the opening smoothly to the both ends of the longitudinal direction of the opening.

In the plate body according to the present invention, the cover plate is formed from a material higher in rigidity than the nozzle plate.

According to this configuration, the cover plate can be made less prone to deform than the nozzle plate. The cover plate thus suppresses the deformation of the nozzle plate due to heat or the like. Accordingly, it is possible to enhance the accuracy of processing the nozzle holes and prevent defective discharge of the liquid ejection heads.

A liquid ejection head according to the present invention includes the plate body and the actuator plate described above.

According to this configuration, it is possible to provide a liquid ejection head that protects the nozzle plate and prevents the breakage of the menisci in the liquid formed in the nozzle holes.

A liquid ejection recording apparatus according to the present invention includes the liquid ejection head described above.

According to this configuration, it is possible to provide a liquid ejection recording apparatus that protects the nozzle plate and prevents the breakage of the menisci in the liquid formed in the nozzle holes.

According to the present invention, when the wiper is moved in either the direction of the nozzle array (along the longer direction of the plate body) or the direction orthogonal to the direction of the nozzle array (along the shorter direction of the plate body) to wipe the cover plate off the liquid or the like, for example, the liquid or the like having flown into the opening can be collected to the both ends of the longitudinal direction of the opening. That is, the liquid or the like having flown into the opening can be collected to the positions as distant from the nozzle hole as possible. Accordingly, it is possible to protect the nozzle plate by the cover plate and prevent the breakage of the menisci in the liquid formed in the nozzle holes due to the liquid or the like having flown into the openings.

### BRIEF DESCRIPTION OF THE DRAWINGS

FIG. 1 is a perspective view illustrating a configuration of a liquid ejection recording apparatus according to an embodiment of the present invention;

FIG. 2 is a perspective view of an inkjet head according to the embodiment of the present invention;

FIG. 3 is a perspective view of a head chip according to the embodiment of the present invention;

FIG. 4 is an exploded perspective view of the head chip according to the embodiment of the present invention;

FIG. 5 is a plane view of a nozzle plate body according to the embodiment of the present invention;

FIG. 6 is a cross-section view of FIG. 5 taken along line A-A;

FIGS. 7A to 7D are diagrams describing a wiping action on the nozzle plate body according to the embodiment of the present invention, which illustrate the behavior of a wiper;

FIG. 8 is a plane view of a modification of openings according to the embodiment of the present invention; and

FIG. 9 is a plane view of a modification of openings according to the embodiment of the present invention.

### DETAILED DESCRIPTION OF THE PREFERRED EMBODIMENTS

### (Liquid Ejection Recording Apparatus)

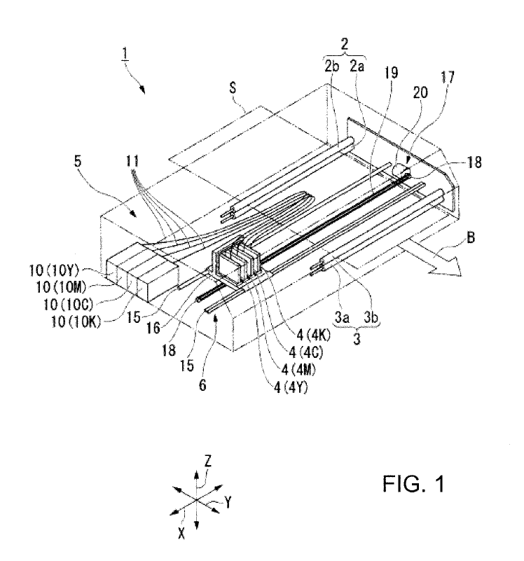

FIG. 1 is a perspective view illustrating a configuration of a liquid ejection recording apparatus 1. In the drawings, the members are scaled as appropriate for easy understanding of the description.

As illustrated in FIG. 1, the liquid ejection recording apparatus 1 includes a pair of conveying units 2 and 3 that convey a recording medium S such as recording paper or the like, inkjet heads 4 that eject an ink (liquid) not illustrated onto the recording medium S, an ink supply unit 5 that supplies the ink to the inkjet heads 4, and a scanning unit 6 that moves the inkjet heads 4 for scanning in a scanning direction X orthogonal to a conveying direction Y of the recording medium S.

In the embodiment, the direction orthogonal to the conveying direction Y and the scanning direction X is set as vertical direction Z.

The pair of conveying units 2 and 3 is spaced in the conveying direction Y. The one conveying unit 2 is located upstream side along the conveying direction Y, and the other conveying unit 3 is located downstream side along the conveying direction Y. These conveying units 2 and 3 include respectively grit rollers 2a and 3a that are extended in the scanning direction X, pinch rollers 2b and 3b that are arranged in parallel to the grit rollers 2a and 3a to pinch the recording medium S between the grit rollers 2a and 3a, and a driving mechanism not illustrated such as a motor that rotates axially the grit rollers 2a and 3a.

The pair of conveying units 2 and 3 rotates the grit rollers 2a and 3a to convey the recording medium S in the direction of arrow B along the conveying direction Y.

The ink supply unit 5 includes ink tanks 10 storing inks and ink tubes 11 connecting the ink tanks 10 and inkjet heads 4.

In the illustrated example, as the ink tanks 10, ink tanks 10Y, 10M, 10C, and 10K storing inks of four colors, yellow (Y), magenta (M), cyan (C), and black (K), respectively, are aligned in the conveying direction Y. The ink tubes 11 are flexible hoses, for example, that can follow the motion (movement) of a carriage 16 supporting the inkjet heads 4.

The scanning unit 6 includes a pair of guide rails 15 that is extended in the scanning direction X and arranged in parallel to each other with a space left therebetween in the conveying direction Y, the carriage 16 movably arranged along the pair of guide rails 15, and a driving mechanism 17 moving the carriage 16 in the scanning direction X.

The driving mechanism 17 is arranged between the pair of guide rails 15 and includes a pair of pulleys 18 spaced in the scanning direction X, an endless belt 19 that is wound around the pair of pulleys 18 and moves in the scanning direction X, and a driving motor 20 rotationally driving the one pulley 18.

The carriage 16 is coupled to the endless belt 19 and is movable in the scanning direction X with movement of the endless belt 19 rotationally driven by the one pulley 18. The carriage 16 is also loaded with the plurality of inkjet heads 4 aligned in the scanning direction X.

In the illustrated example, the carriage 16 is loaded with the four inkjet heads 4 ejecting yellow (Y), magenta (M), cyan (C), and black (K) inks, that is, the inkjet heads 4Y, 4M, 4C, and 4K.

### (Inkjet Head)

Next, one inkjet head 4 will be described in detail.

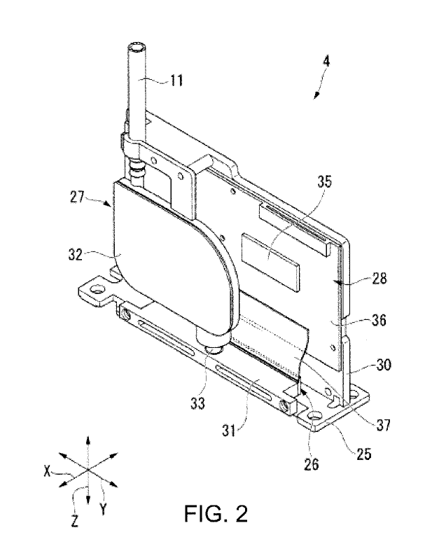

FIG. 2 is a perspective view of the inkjet head 4.

As illustrated in FIG. 2, the inkjet head 4 includes a fixation plate 25 fixed to the carriage 16, a head chip 26 fixed to the fixation plate 25, an ink supplier 27 that supplies the ink supplied from the ink supply unit 5 to an ink introduction hole 41a described later in the head chip 26, and a control unit 28 that applies a drive voltage to the head chip 26.

With application of the drive voltage, the inkjet heads 4 discharge the inks of respective colors by a predetermined discharge amount. At that time, the inkjet heads 4 are moved by the scanning unit 6 in the scanning direction X to make a record in a predetermined area on the recording medium S. This scanning is repeated while the recording medium S is conveyed in the conveying direction Y by the conveying units 2 and 3 to make a record on the entire recording medium S.

The fixation plate 25 has a base plate 30 made from a metal such as aluminum fixed and erected along the vertical direction Z and a flow path member 31 configured to supply the ink into the ink introduction hole 41a described later in the head chip 26. A pressure damper 32 with a storage chamber for storing the ink is arranged over the flow path member 31 and supported by the base plate 30. The flow path member 31 and the pressure damper 32 are coupled together via an ink coupling pipe 33, and the ink tube 11 is connected to the pressure damper 32.

According to this configuration, with a supply of the ink via the ink tube 11, the pressure damper 32 temporarily stores the ink in the internal storage chamber and then supplies a predetermined amount of ink to the ink introduction hole 41a via the ink coupling pipe 33 and the flow path member 31.

The flow path member 31, the pressure damper 32, and the ink coupling pipe 33 act as the ink supplier 27 described above.

The fixation plate 25 also has an IC substrate 36 on which a control circuit (driving circuit) 35 such as an integrated circuit is mounted to drive the head chip 26. The control circuit 35, a common electrode (drive electrode) and individual electrodes described later on the head chip 26 (both of them are not illustrated) are electrically connected together via a flexible substrate 37 on which a wiring pattern not illustrated is printed. This allows the control circuit 35 to apply the drive voltage between the common electrode and the individual electrodes via the flexible substrate 37.

The IC substrate 36 with the control circuit 35 mounted and the flexible substrate 37 act as the control unit 28 described above.

### (Head Chip)

Subsequently, the head chip 26 will be described in detail.

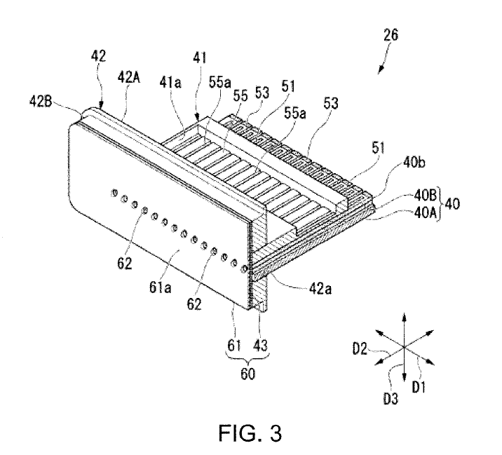

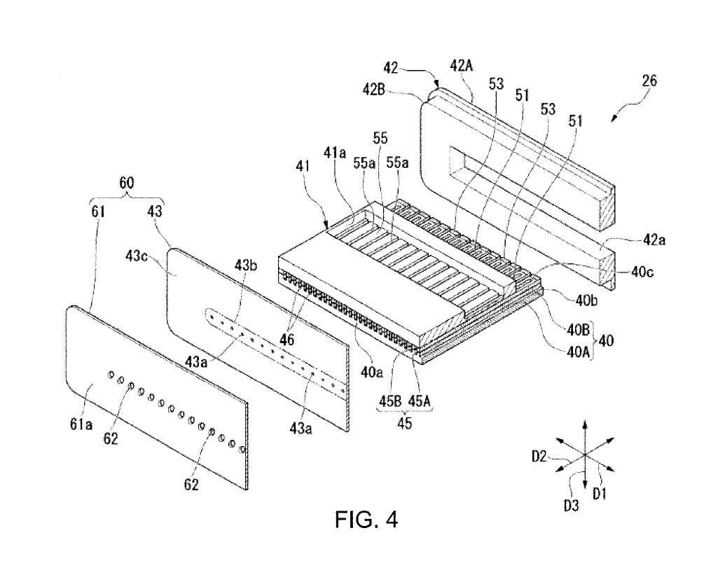

FIG. 3 is a perspective view of the head chip 26. FIG. 4 is an exploded perspective view of the head chip 26.

As illustrated in FIGS. 3 and 4, the head chip 26 includes an actuator plate 40, a cover plate 41, a support plate 42, and a nozzle plate body 60 provided on a side surface of the actuator plate 40.

The head chip 26 is an edge shoot type that discharges the ink from nozzle holes 43a at the longitudinal ends of liquid discharge channels 45A described later.

The actuator plate 40 is a stacked plate in which two plates, that is, a first actuator plate 40A and a second actuator plate 40B are stacked. The actuator plate 40 is not limited to the stacked plate but may be formed from a single plate.

The first actuator plate 40A and the second actuator plate 40B are both piezoelectric substrates polarized in a thickness direction, for example, lead zirconate titanate (PZT) ceramic substrates. They are bonded together with their polarization directions opposite to each other.

The actuator plate 40 is formed in an almost rectangular shape in a planar view, which is longer along a first direction (alignment direction) D1 orthogonal to a thickness direction D3 and shorter along a second direction D2 orthogonal to the thickness direction D3 and the first direction D1.

In the embodiment, the head chip 26 is edge shoot-compatible, and thus the thickness direction D3 aligns with the scanning direction X in the liquid ejection recording apparatus 1, the first direction D1 aligns with the conveying direction Y, and the second direction D2 aligns with the vertical direction Z. That is, of the side surfaces of the actuator plate 40, for example, the side surface opposed to the nozzle plate body 60 (on which the ink is discharged) constitutes a lower end surface 40a, and the side surface opposite to the lower end surface 40a along the second direction D2 constitutes an upper end surface 40b.

In the following description, the vertical direction may refer to simply the downward direction or the upward direction. However, it is to be noted that the vertical direction generally changes depending on the installation angle of the liquid ejection recording apparatus 1.

In addition, in the following description, the thickness direction D3 of the actuator plate 40 will be called third direction D3 orthogonal to the first direction D1 and the second direction D2 in order to avoid confusion between the thickness direction D3 of the actuator plate 40 and the thickness direction of another member.

One main surface 40c of the actuator plate 40 (where the cover plate 41 overlaps) has a plurality of channels 45 aligned with a predetermined spacing in the first direction D1. The plurality of channels 45 is grooves opened on the one main surface 40c and extended linearly along the second direction D2. The channels 45 are opened at one longitudinal side on the lower end surface 40a side of the actuator plate 40. The plurality of channels 45 has therebetween drive walls (piezoelectric division walls) 46 almost rectangular in cross-section and extending in the second direction D2. Each of the channels 45 are sectioned by the drive walls 46.

The plurality of channels 45 is roughly divided into the liquid discharge channels 45A to be filled with the ink and non-discharge channels 45B not to be filled with the ink. The liquid discharge channels 45A and the non-discharge channels 45B are alternately arranged in the first direction D1.

Among them, the liquid discharge channels 45A are not opened on the upper end surface 40b side of the actuator plate 40 but are opened only on the lower end surface 40a side of the actuator plate 40. In contrast to this, the non-discharge channels 45B are opened on both the lower end surface 40a side and the upper end surface 40b side of the actuator plate 40.

Common electrode not illustrated is formed on the inner wall surfaces of the liquid discharge channel 45A, that is, on a pair of side wall surfaces and a bottom wall surface opposed to each other in the first direction D1. The common electrode extends in the second direction D2 along the liquid discharge channel 45A and is electrically continuous with a common terminal 51 on the one main surface 40c of the actuator plate 40.

Meanwhile, individual electrodes not illustrated are formed on, of the inner wall surfaces of the non-discharge channel 45B, a pair of side walls opposed to each other in the first direction D1. These individual electrodes extend in the second direction D2 along the non-discharge channel 45B and are electrically continuous with individual terminals 53 on the one main surface 40c of the actuator plate 40.

The individual terminals 53 are formed nearer the upper end surface 40b of the actuator plate 40 than the common terminal 51 on the one main surface 40c of the actuator plate 40. The individual terminals 53 are formed to connect the individual electrodes on the both sides of the liquid discharge channels 45A (the individual electrodes formed in the different non-discharge channels 45B).

According to this configuration, the control circuit 35 applies a drive voltage between the common electrode and the individual electrodes via the flexible substrate 37 through the common terminals 51 and the individual terminals 53 to deform the drive walls 46. Then, pressure fluctuation occurs in the ink charged in the liquid discharge channels 45A. Accordingly, the ink in the liquid discharge channels 45A can be discharged from the nozzle holes 43a to record various kinds of information such as characters and graphics on the recording medium S.

The cover plate 41 is overlaid on the one main surface 40c of the actuator plate 40. The cover plate 41 has an ink introduction hole 41a formed in an almost rectangular shape in a planar view and made longer along the first direction D1.

The ink introduction hole 41a has an ink introduction plate 55 with a plurality of slits 55a to introduce the ink supplied via the flow path member 31 into the liquid discharge channels 45A and restrict the introduction of the ink into the non-discharge channels 45B. That is, the plurality of slits 55a is formed at positions corresponding to the liquid discharge channels 45A so that the ink can be charged into only the liquid discharge channels 45A.

The cover plate 41 is formed from a PZT ceramic substrate as the actuator plate 40 is, for example. The cover plate 41 is thermally expanded as the actuator plate 40 to suppress warp and deformation with temperature changes. However, the present invention is not limited to this but the cover plate 41 may be formed from a material different from that for the actuator plate 40. In this case, the material for the cover plate 41 is preferably close to the material for the actuator plate 40 in coefficient of thermal expansion.

The support plate 42 supports the overlaid actuator plate 40 and cover plate 41 and also supports the nozzle plate body 60 at the same time. The support plate 42 is an almost rectangular plate material that is longer along the first direction D1 in correspondence with the actuator plate 40 and has a fitting hole 42a penetrating in the thickness direction at the central large portion. The fitting hole 42a is formed in an almost rectangular shape along the first direction D1. The overlaid actuator plate 40 and cover plate 41 are supported while being fitted into the fitting hole 42a.

The support plate 42 is formed as a stepped plate such that the outer shape is smaller with a step toward the lower end along the thickness direction. Specifically, the support plate 42 is formed such that a base portion 42A positioned on the upper end side along the thickness direction and a step portion 42B arranged on the lower end surface of the base portion 42A and made smaller in outer shape than the base portion 42A are integrally molded. The support plate 42 is assembled such that the end surface of the step portion 42B is flush with the lower end surface 40a of the actuator plate 40. The nozzle plate body 60 is fixed to the end surface of the step portion 42B with an adhesive or the like, for example.

### (Nozzle Plate Body)

The nozzle plate body 60 is formed from a nozzle plate 43 in contact with the lower end surface 40a of the actuator plate 40 and a nozzle cover plate 61 provided on a discharge surface 43c of the nozzle plate 43 opposite to the actuator plate 40.

### (Nozzle Plate)

The nozzle plate 43 is a sheet made from a film material of polyimide or the like, for example. However, the material for the nozzle plate 43 is not limited to polyimide but may be another resin material, metallic material (for example, stainless steel), silicon, or the like.

The nozzle plate 43 is sized in correspondence with the outer shape of the step portion 42B of the support plate 42. That is, the nozzle plate 43 is formed in an almost rectangular shape to be longer along the first direction D1.

The nozzle plate 43 has the plurality of nozzle holes 43a formed with predetermined spaces therebetween along the first direction D1. The nozzle holes 43a are tapered with gradual increase in diameter toward the actuator plate 40. These nozzle holes 43a are formed at positions opposed to the plurality of liquid discharge channels 45A and are aligned in one line to form a nozzle array 43b. The nozzle holes 43a communicate with the corresponding liquid discharge channels 45A. Proper menisci are generally held in the nozzle holes 43a so as not to discharge the ink from the nozzle holes 43a.

### (Nozzle Cover Plate)

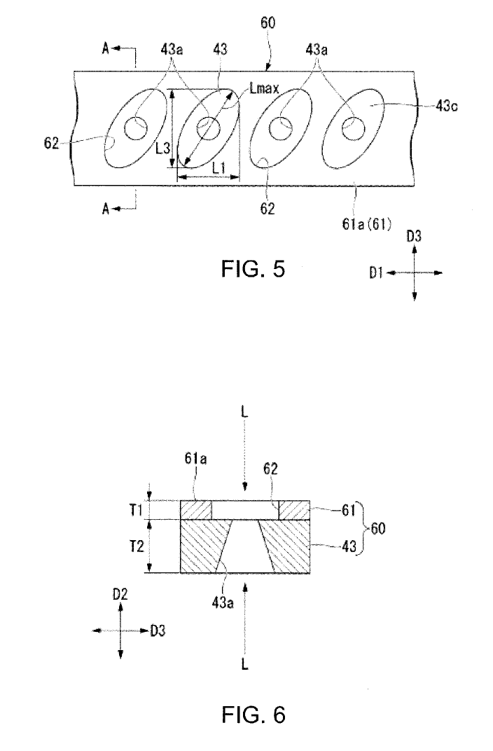

FIG. 5 is a plane view of the nozzle plate body 60 as seen from the side opposite to the actuator plate 40. FIG. 6 is a cross-section view of FIG. 5 taken along line A-A.

As illustrated in FIGS. 3 to 6, the nozzle cover plate 61 is stuck and fixed to the discharge surface 43c of the nozzle plate 43 by thermal compression bonding. The nozzle cover plate 61 is desirably formed from a material higher in rigidity than the nozzle plate 43. For example, the nozzle cover plate 61 is formed by pressing or etching a stainless-steel thin plate or the like.

A water-repellent film is applied to a surface 61a of the nozzle cover plate 61 opposite to the nozzle plate 43. This suppresses the residual ink remaining on the nozzle cover plate 61 as much as possible. The discharge surface 43c of the nozzle plate 43 and the surface of the nozzle cover plate 61 to be bonded to the discharge surface 43c are desirably hydrophilic. This configuration enhances the bonding force of the nozzle plate 43 and the nozzle cover plate 61.

However, the present invention is not limited to this but a water-repellent film may be applied to the discharge surface 43c of the nozzle plate 43. Applying a water-repellent film to the discharge surface 43c as well suppresses the residual ink remaining on the discharge surface 43c. In addition, no water-repellent film may be applied to the surface 61a of the nozzle cover plate 61.

The outer shape of the nozzle cover plate 61 is almost the same as the outer shape of the nozzle plate 43. Specifically, the nozzle cover plate 61 is formed in an almost rectangular shape longer along the first direction D1 to cover the entire discharge surface 43c of the nozzle plate 43. A thickness T1 of the nozzle cover plate 61 is smaller than a thickness T2 of the nozzle plate 43.

Further, the nozzle cover plate 61 has openings 62 penetrating in the thickness direction at positions corresponding to the nozzle holes 43a. The openings 62 are formed in an almost oval shape such that the direction crossing the two directions D1 and D3, that is, the third direction D3 (the shorter direction of the nozzle cover plate 61) and the first direction D1 (the direction of the nozzle array 43b) constitutes a longitudinal direction Lmax.

In addition, the openings 62 are formed such that a projection length L1 along the first direction D1 is shorter than a projection length L3 along the third direction D3.

Further, the opening areas of the openings 62 are set to be larger than the opening areas of the nozzle holes 43a. Accordingly, the entire nozzle holes 43a are exposed to the surface 61a of the nozzle cover plate 61 via the openings 62. Moreover, the both ends of the longitudinal direction of the openings 62 are most distant from the nozzle holes 43a in the openings 62.

### (Method for Manufacturing Nozzle Plate Body)

Next, a method for manufacturing the nozzle plate body 60 will be described.

First, the nozzle plate 43 and the nozzle cover plate 61 are formed in predetermined outer shapes. Then, the nozzle cover plate 61 is arranged on the discharge surface 43c of the nozzle plate 43 and the nozzle plate 43 and the nozzle cover plate 61 are bonded together by thermal compression bonding.

Next, the openings 62 are formed in the nozzle cover plate 61 by etching. The nozzle cover plate 61 may be formed in a predetermined outer shape at the same time as the formation of the openings 62 by etching.

Next, as illustrated in FIG. 6, the nozzle plate 43 is irradiated with laser light L. Then, the nozzle holes 43a are formed to be concentric with the openings 62. At that time, the nozzle plate 43 may be irradiated with the laser light L from the nozzle plate 43 side (see the solid arrow in FIG. 6) or may be irradiated with the laser light L from the nozzle cover plate 61 side via the openings 62 (see the dashed arrow in FIG. 6).

At that time, the nozzle plate 43 is heated by the laser light L but the thermal deformation of the nozzle plate 43 is suppressed due to the attachment of the nozzle cover plate 61. Accordingly, the nozzle holes 43a can be formed with high accuracy. Then, after the formation of the nozzle holes 43a, the nozzle plate 43 and the nozzle cover plate 61 (the nozzle plate body 60) are completely manufactured.

### (Operations of Liquid Ejection Recording Apparatus)

Next, operations of the liquid ejection recording apparatus 1 will be described.

First, the ink is charged into the liquid discharge channels 45A in the head chips 26. Before the starting of the liquid ejection recording apparatus 1, proper menisci are held in the nozzle holes 43a so that the ink is not discharged from the nozzle holes 43a.

As illustrated in FIG. 1, in order to record information on the recording medium S by the liquid ejection recording apparatus 1, for example, the inkjet heads 4 are reciprocated by the scanning unit 6 via the carriage 16 in the scanning direction X while the recording medium S is conveyed by the pair of conveying units 2 and 3 in the conveying direction Y.

In the meantime, in the individual inkjet heads 4, the control circuit 35 applies a drive voltage between the common terminal 51 and the individual terminals 53. Accordingly, the drive walls 46 undergo thickness slip deformation, and a pressure wave occurs in the ink charged in the liquid discharge channels 45A. The pressure wave increases the internal pressure in the liquid discharge channels 45A to allow the ink to be discharged from the nozzle holes 43a. At that time, the ink turns into ink droplets while passing through the nozzle holes 43a, and the ink droplets are discharged via the openings 62 in the nozzle cover plate 61. As a result, various kinds of information such as characters and graphics can be recorded on the recording medium S by the inks of four colors.

The nozzle cover plate 61 is attached to the discharge surface 43c of the nozzle plate 43. The nozzle cover plate 61 is made from stainless steel or the like higher in rigidity than the nozzle plate 43. Accordingly, even though the nozzle plate 43 is made from a resin such as polyimide, the thermal deformation of the nozzle holes 43a can be reliably suppressed. This makes it possible to stabilize the amount of ink discharged from the head chips 26 regardless of environmental temperature to make a record on the recording medium S with high accuracy.

(Wiping Action on Nozzle Plate Body and Operations of Openings in Nozzle Cover Plate)

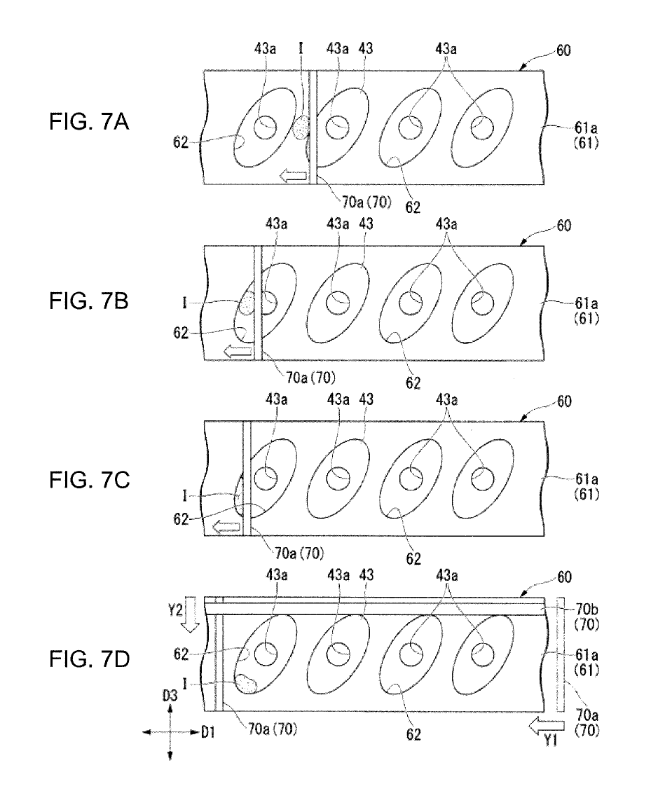

Next, the operations of the openings 62 in the nozzle cover plate 61 and the wiping action on the nozzle plate body 60 will be described in detail with reference to FIGS. 7A to 7D.

FIGS. 7A to 7D are diagrams describing a wiping action on the nozzle plate body, which illustrate the behavior of a wiper 70.

As illustrated in FIG. 7D, the wiping action on the nozzle plate body 60 (hereinafter, called simply wiping action) is carried out by the wiper 70 provided in the liquid ejection recording apparatus 1. Specifically, the wiper 70 is moved along the longitudinal side of the nozzle plate body 60 (in the first direction D1) (see a wiper 70a and an arrow Y1) or along the shorter direction of the nozzle plate body 60 (in the third direction D3) (see a wiper 70b and an arrow Y2) to perform the wiping action. In addition, the wiping action is carried out by reciprocating the wiper 70 from one end of the nozzle plate body 60 along the longer direction or the shorter direction to the other end of the nozzle plate body 60 along the longer direction or the shorter direction.

The following description is based on the assumption that the wiper 70 is moved along the longer direction of the nozzle plate body 60 (in the first direction D1). In addition, in the following description, the forward side of movement direction of the wiper 70 will be called downstream side and the backward side of movement direction of the wiper 70 will be called upstream side. Referring to FIGS. 7A to 7D, the wiper 70 moves from the right side to left side in a plane view, and thus the right side of the plane constitutes the upstream side in the direction of the wiping action and the left side of the plane constitutes the downstream side in the direction of the wiping action. Although not illustrated, in contrast, when the wiper 70 moves from the left side to right side of the plane, the left side of the plane constitutes the upstream side in the direction of the wiping action, and the right side of the plane constitutes the downstream side in the direction of the wiping action.

First, as illustrated in FIG. 7A, when the wiper 70 is moved with an ink I left on the surface 61a of the nozzle cover plate 61, the ink I is drawn by the wiper 70 and flown into the opening 62 in the nozzle cover plate 61 as illustrated in FIG. 7B. Then, the ink I is continuously drawn by the wiper 70 up to the inner peripheral edge of the opening 62 on the downstream side.

The opening 62 is formed in an almost oval shape such that the direction crossing the two directions D1 and D3, that is, the first direction D1 (the direction of the nozzle array 43b) and the third direction D3 constitutes the longitudinal direction Lmax. Accordingly, when the wiper 70 is continuously moved toward the downstream side as illustrated in FIG. 7C, the ink I is obliquely drawn as extruded by the wiper 70 and the inner peripheral edge of the opening 62 along the inner peripheral edge. Then, the ink I reaches one end of the opening 62 along the longitudinal direction.

When the wiper 70 further moves toward the downstream side, the ink I remains at the one end of the opening 62 along the longitudinal direction as illustrated in FIG. 7D. That is, the ink I is collected in the opening 62 at the position most distant from the nozzle hole 43a.

This behavior of the ink I is also applied to the case in which the wiper 70 (70b) is moved along the shorter direction of the nozzle plate body 60 (in the third direction D3).

In the foregoing embodiment, the openings 62 in the nozzle cover plate 61 are formed in an almost oval shape such that the direction crossing the two directions D1 and D3, that is, the first direction D1 (the direction of the nozzle array 43b) and the third direction D3 constitutes the longitudinal direction Lmax. Accordingly, even though the wiper 70 is moved along the longitudinal side of the nozzle plate body 60 (in the first direction D1) (see the wiper 70a and the arrow Y1) or along the shorter direction of the nozzle plate body 60 (see the wiper 70b and the arrow Y2) to wipe the ink or the like off the nozzle cover plate 61 by the wiper 70, the ink or the like having flown into the opening 62 of the nozzle cover plate 61 can be collected to the both ends of the longitudinal direction of the opening 62. That is, the ink or the like having flown into the opening 62 can be collected to the positions as distant from the nozzle hole 43a as possible. Accordingly, it is possible to protect the nozzle plate 43 by the nozzle cover plate 61 and prevent the breakage of the menisci in the ink formed in the nozzle holes 43a due to the ink or the like having flown into the openings 62.

The individual nozzle holes 43a have the opening 62, and the nozzle plate 43 can be covered with the nozzle cover plate 61 as much as possible to protect the nozzle plate 43 in a reliable manner. Further, the openings 62 are formed in an oval shape such that the projection length L1 along the first direction D1 is shorter than the projection length L3 along the third direction D3. Accordingly, it is easy to form the space between the adjacent openings 62 while narrowing the pitch of the nozzle holes 43a to meet the demand for finer details of images and characters recorded on the recording medium S. This prevents the adjacent openings 62 from communicating with each other and avoids the spread of the ink or the like on the nozzle cover plate 61 into the openings 62.

Further, the openings 62 are formed in an almost oval shape to make the inner peripheral edges of the openings 62 smooth. This makes it possible to move smoothly the ink or the like flowing into the openings 62 to the both ends of the longitudinal direction of the openings 62.

The nozzle cover plate 61 is formed from a material higher in rigidity than the nozzle plate 43, for example, stainless steel or the like. This makes the nozzle cover plate 61 less prone to deform than the nozzle plate 43, and the deformation of the nozzle plate 43 can be suppressed by the nozzle cover plate 61. As a result, it is possible to enhance the processing accuracy of the nozzle holes 43a and prevent defective discharge from the inkjet heads 4. In addition, the use of stainless steel makes the nozzle cover plate 61 more effective of rust prevention.

### (Other Modifications)

The present invention is not limited to the foregoing embodiments but includes various modifications of the foregoing embodiments without deviating from the gist of the present invention.

For example, in the foregoing embodiments, out of piezo inkjet heads, wall bend-type inkjet heads are taken. However, the present invention is not limited to this. For example, the foregoing embodiments may be applied to, out of piezo inkjet heads, roof shoot-type inkjet heads (the direction of pressure application to inks and the direction of ink droplet discharge are the same) or other piezo inkjet heads.

In addition, the present invention is not limited to piezo inkjet heads but foregoing embodiments are also applicable to thermal inkjet heads and others.

Further, in the foregoing embodiments, the head chips 26 are edge shoot-type head chips that discharge the ink from the nozzle holes 43a at the longitudinal ends of the liquid discharge channels 45A. However, the present invention is not limited to this. The foregoing embodiments can also be applied to side shoot-type head chips that discharge the ink from the nozzle holes in the longitudinal centers of the liquid discharge channels 45A.

In the foregoing embodiments, the nozzle cover plate 61 is bonded to the nozzle plate 43 by thermal compression bonding. However, the present invention is not limited to this. The nozzle plate 43 and the nozzle cover plate 61 may be bonded together with an adhesive.

In the method for manufacturing the nozzle plate body 60 described above, the nozzle cover plate 61 is bonded to the nozzle plate 43, then the openings 62 are formed in the nozzle cover plate 61 by etching, and then the nozzle holes 43a are formed in the nozzle plate 43 by the laser light L. However, the method for manufacturing the nozzle plate body 60 is not limited to this. Alternatively, the nozzle plate body 60 may be manufactured such that the nozzle holes 43a are formed in advance in the nozzle plate 43, then the openings 62 are formed in the nozzle cover plate 61, and then the nozzle plate 43 and the nozzle cover plate 61 are bonded together.

In the foregoing embodiments, the nozzle cover plate 61 has the openings 62 penetrating in the thickness direction at the positions corresponding to the nozzle holes 43a. In addition, the openings 62 are formed in an almost oval shape such that the direction crossing the two directions D1 and D3, that is, the first direction D1 (the direction of the nozzle array 43b) and the third direction D3 constitutes the longitudinal direction Lmax. However, the present invention is not limited to this but the openings 62 may be formed to communicate with at least one nozzle hole 43a. In addition, the openings 62 may be Ruined only such that the direction crossing the two directions D1 and D3, that is, the first direction D1 and the third direction D3 constitutes the longitudinal direction Lmax. These cases will be specifically described below.

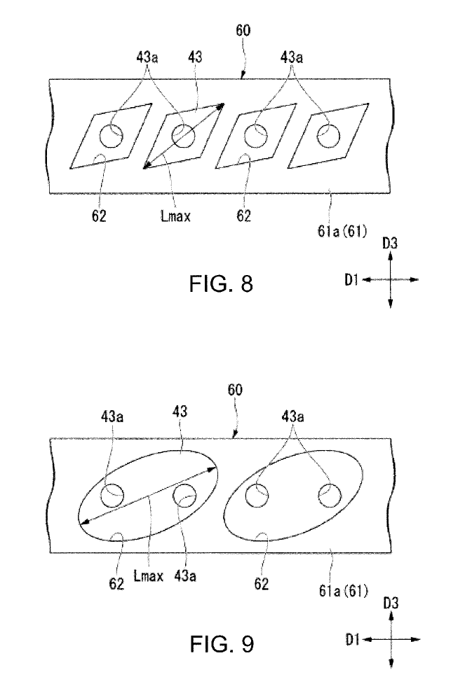

FIGS. 8 and 9 are plane views of modifications of the openings 62 in the nozzle cover plate 61, which correspond to FIG. 5.

As illustrated in FIG. 8, the openings 62 may be formed in an almost rhomboidal shape such that the direction crossing the two directions D1 and D3, that is, the first direction D1 and the third direction D3 constitutes the longitudinal direction Lmax.

In addition, as illustrated in FIG. 9, the opening areas of the openings 62 may be set to be larger so that one opening 62 communicates with the two nozzle holes 43a. Further, the opening areas of the openings 62 may be set to be larger so that one opening 62 communicates with the two or more nozzle holes 43a.

These configurations produce the same advantages as those of the foregoing embodiments.

What is claimed is:

1. A plate body comprising:
a nozzle plate that is provided on an actuator plate having a plurality of channels to be filled with a liquid and has a nozzle array composed of a plurality of nozzle holes respectively communicating with the plurality of channels; and
a cover plate that is provided on a discharge surface of the nozzle plate from which the liquid is discharged and has an opening communicating with at least one of the nozzle holes, wherein
the opening is formed such that a direction crossing a direction of the nozzle array and a direction orthogonal to the direction of the nozzle array constitutes a longitudinal direction of the opening.

2. The plate body according to claim 1, wherein the opening is formed such that a projection length along the direction of the nozzle array is smaller than a projection length along the direction orthogonal to the direction of the nozzle array.

3. The plate body according to claim 1, wherein the cover plate has the respective openings for each of the nozzle holes.

4. The plate body according to claim 1, wherein the opening has an oval shape.

5. The plate body according to claim 1, wherein the cover plate is formed from a material higher in rigidity than the nozzle plate.

6. A liquid ejection head comprising:
the plate body according to claim 1; and
the actuator plate.

7. A liquid ejection recording apparatus comprising the liquid ejection head according to claim 6.
